(19) United States
(12) Patent Application Publication
(10) Pub. No.: US 2008/0215340 A1
(43) Pub. Date: Sep. 4, 2008

(54) Compressing Method for Digital Audio Files

(76) Inventors: Wen-Yu Su, Taipei Taiwan (CN); Chang-Wci Chen, Taipei Taiwan (CN); Jing-Xin Wang, Taipei Taiwan (CN)

Correspondence Address: Wen-Yu Su;Wen-Yu Su, 235 Chung - Ho Box 8-24 Taipei, Taiwan, R. O. C., 235 Chung - Ho Box 8-24 Taipei, Taiwan, R. O. C., Taipei, 235, omitted

(21) Appl. No.: 11/914,453

(22) PCT Filed: May 25, 2005
(86) PCT No.: PCT/CN2005/000724

§ 371 Date: Nov. 15, 2007

(51) Int. Cl. G10L 19/00

(52) U.S. Cl. 704/500; 704/E19.001

(57) ABSTRACT

A compressing method for digital audio files mainly utilizes a harmonic structure quad tree (HSQT) to re-arrange the frequency coefficient in each frame, and applies concurrent encoding in hierarchical trees (CEIHT) algorithm to increase and simplify the processing speed; the coefficient of the CEIHT is symbolized according to an arithmetic coding; the record of the probability of the symbol is used to determine the number of bits to be stored; the probability is in inverse order of the number of bits requiring storage, and thus increasing the occurrence probability of the symbol may greatly reduce the number of bits to be stored. As a result, the overall compressing method is done in simplified processing procedures and outputting an audio compressed file with a high compression ratio.

The present invention requests the priority of PCT, which is filed on May 25, 2005 as PCT international application No. PCT/CN2005/000724 which is assigned and disclosed by the applicants of the present invention. The contents of the PCT international application is incorporated into the present invention as a part of the present invention.

### FIELD OF THE INVENTION

The present invention relates to a compressing method of a digital audio file, utilizing a discrete cosine transform (DCT) to transform signals from time domain to frequency domain, and performing frame sampling and tree distribution arrangement to achieve the compression without loss.

### BACKGROUND OF THE INVENTION

MPEG is the most well-known technology in video and audio compressed file. The standard of MPEG-1 divides the compression standard of an audio signal into three layers, namely MPEG LAYER 1, MPEG LAYER 2 and MPEG LAYER 3. DVD adopts LAYER 2 standard, while MP3 is the product of MPEG LAYER 3. In general, MP3 stores the music files on CD by ways of compression. Through the powerful computing capability of the CPU, the files are decompressed by software such that users can listen to the music on the computer. As for the compression result, those skilled in the art can calculate as follows: music files on CD in general have the frequency of 44.1 kHz on each channel, and are sampled with 16 bits, and thus one minute of music will need a capacity of 44100×16×2 (stereo)×60 bits for storage, that is approximately 10 MB of storage space. Taking an example of a CD with the storage capacity of 650 MB now on the market, the volume of storage for one CD is between 65 to 75 minutes. MP3 increases the volume of storage by compressing the music.

Since the compression ratio of MP3 is approximately between 10 to 12 multiples, one minute of music will only need approximately 1 MB of storage space through MP3 compression. In other words, each CD is able to store 650 to 750 minutes of music. More importantly, the quality of the music can still compare to that of CD under such compression rate. This is due to the effect of human auditory mask. When MP3 is decompressed with the CPU speed of the current PC, human auditory system cannot distinguish the difference after compression. As a result, the user will not need to compromise listening quality for high storage capacity.

The compression of MPEG/audio has sampling rates of 32 kHz, 44.1 kHz, 48 kHz and supports channels of monophonic, dual monophonic, stereo mode, joint-stereo mode, CRC error detection code for error detection and ancillary data. MPEG/audio utilizes the auditory mask generated in human auditory system under certain situations that cannot distinguish quantization noise. Since the conscious range of human auditory system is at a frequency range between 20 Hz and 20 kHz, the critical band cannot completely present the audio characteristics of the human auditory system. Because human auditory system distinguishes sound energy by frequency, noise mask of any frequency is only related to signals near the certain frequency band. MPEG/audio divides audio signals into a subband near a critical band, and then quantisizes the signals based on the quantization noise in each subband. The most effective compression is to remove the futile quantization noise. In other words, we can remove a lot of data that cannot be observed by the human auditory system, and thus reduce the data size and achieve the compression effect.

Utilizing the human ear masking effect allows the portion that cannot be listened or distinguished by human ears to be omitted and makes it possible that only the portion that can be distinguished is compressed. Thus, the volume of data compression is reduced, and the size of the compressed file is further reduced.

### SUMMARY OF THE INVENTION

The present invention discloses a compressing method for a digital audio file. The present invention takes sampling rate for audio signals, and then the sampling rate is used as a basis for storing bits according to an occurrence probability thereof That is, the sampling rate with higher occurrence probability will utilize fewer storage bits, vice versa. A tree-structured storage bit is made based on the occurrence probability. That is, the sampling rate occurred more frequently is used as a root, and then the bit is stored in the tree structure from high occurrence probability to low occurrence probability, thereby reducing storage of repeated sampling rate so as to greatly reduce the storage bit. At decompression, the sampling rate with the same occurrence probability can be retrieved at the same storage bit so as to restore the file. As a result, loss will not occur in the file during compression and decompression. The need to achieve high compression ratio is also met. Furthermore, the discrete cosine transform and Fast Fourier Transform are utilized to reduce the processing time for file compression and decompression.

Files of conventional compression formats such as JPEG and MPEG may typically have loss while high compression ratio is pursued. JPEG utilizes wavelet transform to extend the image, and thus the longer compression processing time is required that may induce loss. As to MPEG 3 files, in order to achieve high compression ratio for the audio file, the portion which most people cannot hear is cut off, Higher compression ratio can be obtained if the scope of the cutoff is smaller; however, loss may be caused to the original audio signal.

Thus, the present invention discloses a simplified and fast compressing process, allowing the compressed signal to have a high compression ratio with less loss, thereby satisfying the need for high quality digital audio signal; meanwhile, the present invention may be applied to a great scope. For example, the present invention may be applied to the network to provide high quality audio effect. When applied to a portable audio player, the present invention provides greater storage of high quality audio files under the same capacity as compared with the conventional compressing method.

To achieve above object, the present invention provides a compressing method for a digital audio file comprising: writing an audio file signal or analyzing an audio file information for to encoding procedures; reading audio raw data; cutting out a frame from a signal according to a frame size and an overlap-add size; using a discrete cosine transform or inverse transform; using a harmonic structure quad tree; and encoding a frequency coefficient by employing a CEIHT algorithm and arithmetic coding (AC) on said harmonic structure quad tree so as to complete encoding of a frame.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein;

FIG. 1 is the flow chart of the basic encoding process in accordance with the present invention;

FIG. 2 is the flow chart of the HSQT construction in accordance with the present invention;

FIG. 3 is the schematic view illustrating the selection of the root candidate in accordance with the present invention;

FIG. 4 is a schematic view of the exemplary HSQT construction of FIG. 1 in accordance with the present invention;

FIG. 5 is a schematic view of the tree structure in accordance with the present invention;

FIG. 6 is a flow chart of the CEIHT algorithm in accordance with the present invention;

FIG. 7 is a flow chart of the threshold value initialization in FIG. 6;

FIG. 8 is a flow chart of the list initialization in FIG. 6;

FIG. 9 is a flow chart of the sort pass in FIG. 6;

FIG. 10 is a flow chart of LIP pass in accordance with the present invention;

FIG. 11 is a flow chart of the entry in LIS in accordance with the present invention;

FIG. 12 is a flow chart of refinement pass in accordance with the present invention;

FIG. 13 is a flow chart of quantization coefficient update in accordance with the present invention; and

FIG. 14 is a flow chart of basic decoding in accordance with the present invention.

### DETAILED DESCRIPTION OF THE EMBODIMENTS

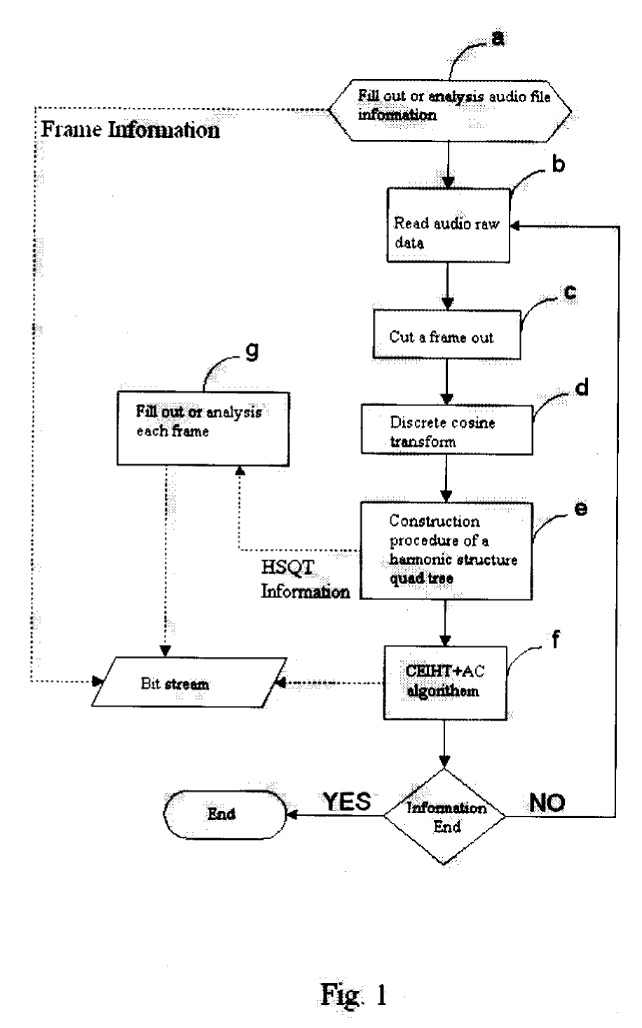

The present invention provides a compressing method for a digital audio file. As shown in FIG. 1, which illustrates the flow chart of the basic encoding process, the encoding process of the present invention is one-pass, non-iterative and includes the following steps:

Step a. prior to the encoding process, audio file signal is filled out and audio file information is analyzed; the audio file information includes sampling rate, word length, frame size, total number of frames, and overlap-add size, etc;

Step b. read audio raw data; audio raw data is usually the curve signal encoded by PCM;

Step c. cut a frame out from a signal according to the length of the frame and the overlap-add size;

Step d. convert the signal from time domain to frequency domain by using discrete cosine transform (DCT);

For example, the one-dimensional DCT X[k] of a sequence x[n] with a length N of can be expressed as:

$$X [ k ] = α [ k ] {\sum }_{n = 0}^{N - 1} x [ n ] cos ( \frac{( 2 n + 1 ) π k}{2 N} ) , k = 0 , 1 , … , N - 1 \qquad ( 1 )$$

The inverse DCT is:

$$x [ n ] = {\sum }_{k = 0}^{N 1} α [ k ] X [ k ] cos ( \frac{( 2 n + 1 ) π k}{2 N} ) , n = 0 , 1 , … , N - 1 , \qquad ( 2 )$$

In formulas 1 and 2, α[k] is defined as:

$$α [ k ] = \{ \begin{matrix}\sqrt{\frac{1}{N}} & for k = 0 \\ \sqrt{\frac{2}{N}} & for k = 1 , 2 , … , N - 1\end{matrix} .$$

In implementation, the adaptation of N point Fast Fourier Transform (FFT) can effectively increase the computing speed.

Step e. Through the construction procedure of a harmonic structure quad tree (hereinafter referred to as the HSQT), construct a plurality of HSQTs;

Step f. Encode these trees with concurrent encoding in hierarchical trees (CEIHT) and arithmetic coding (AC) to have frequency coefficients, thereby completing the encoding of a frame.

With respect to auxiliary data, as shown by dotted lines, the information on HSQT obtained at Step e can be written, or each frame can be analyzed at Step g so as to obtain the total number of HQSTs and the respective root index. The respective root index together with the frame information obtained at Step a as well as the encoding frequency coefficient obtained at Step f, bit stream are integratedly encoded at Step h.

The aforementioned HSQT (Harmonic Structure Quad Tree) is a tree structure established in accordance with the relationships between the magnitude and the power in the frequency of the audio signal. The HSQT is designed according a typical audio signal having two characteristics in its frequency:
1. The power is centralized in the harmonic structure; i.e. the collection of the fundamental frequency as the initial value, and the harmonics thereof wherein and the frequency and harmonics are approximately in multiple relations.
2. The frequencies in each harmonic structure from low to high are in an approximately exponential decrement relationship

Most audio signals may include the harmonic structure generated by music instruments and human beings. They can be assumed as a plurality of different HSQTs. Before explaining how to construct the tree structure, three terms are defined as below:
Pitch Range: this is the possible distribution area the fundamental frequency of the audio signal can cover; it can also be seen as the possible frequency location for all the tree roots.
Search Range: when a tree structure is constructed, if a coefficient a is to be selected, but this coefficient has already bee selected when constructing a previous tree, then the search range is used to find a substitute coefficient b near the coefficient a for substitution.
Complement quad tree: when all of the HSQT to be retrieved have been constructed, the remaining coefficients may form a complement set. A quad tree is established for these coefficients.

The symbols used by the HQST constructing method provided by the present invention are as follows:
root candidate list: the pitch range indices after sequencing, {fᵢ₀|i=1,2, . . . , N}.
multiple indices: {fᵢⱼ|fᵢⱼ=j×fᵢ₀, j=1,2, . . . , Nᵢ} is all of the multiple indices in the frame for fᵢ₀.
substitute indices: {gₖ|k=1,2, . . . , M} is all of the substitute indices within the search range for fᵢⱼ; assume search range is set between −3 and 3, then M=6 and gₗ=fᵢⱼ−3, . . . , g₃=fᵢⱼ−1, g₄=fᵢⱼ+1, . . . , g₆=fᵢⱼ+3.
Total number of HSQTs: value Q includes the last complement quad tree.

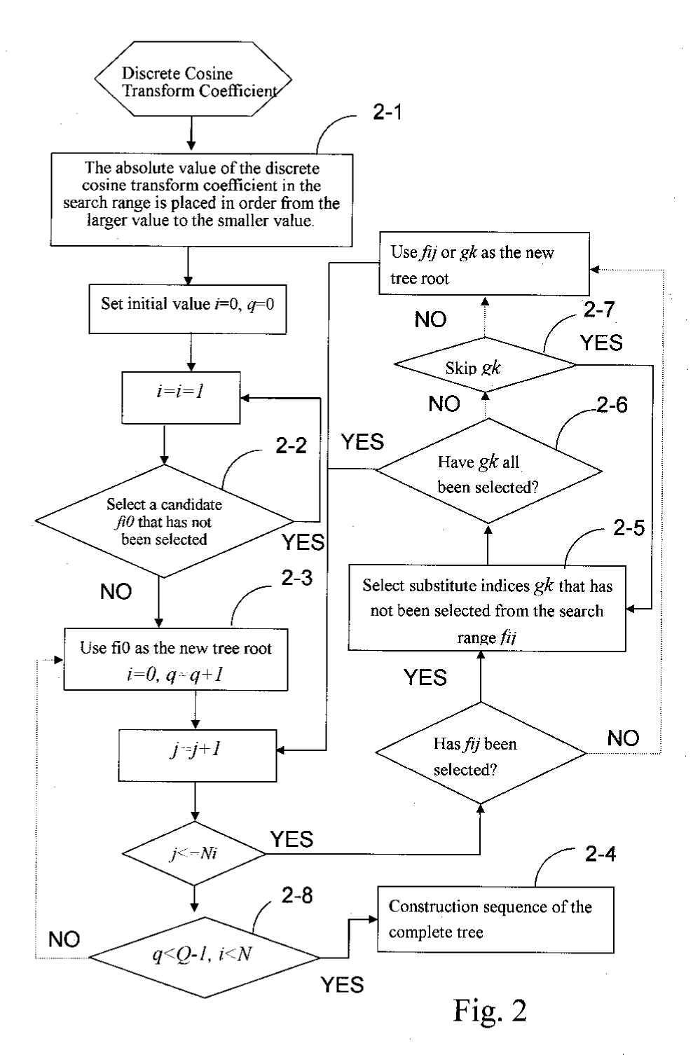

The flow chart of HSQT construction shown in FIG. 2 is explained as follows: Root Candidate Selection Step:

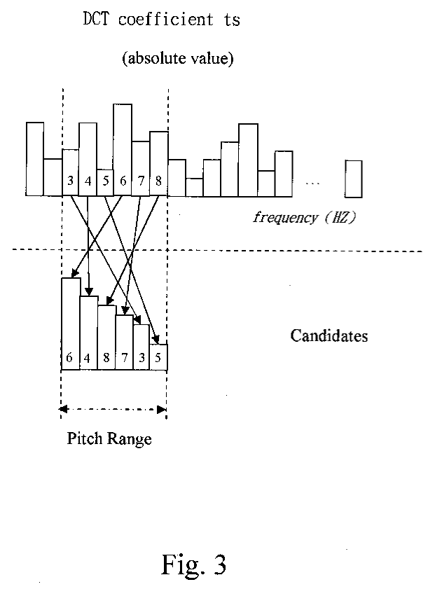

Step 2-1: Please refer to FIG. 3. The absolute value of the discrete cosine transform coefficient in the search range is placed in order from the larger value to the smaller value. This order is the root candidate list, {fᵢ₀|i=1,2, . . . , N}.

### Quad Tree Construction Step:

Step 2-2: Select a candidate fᵢ₀ that has not been selected from the root candidate list and use its coefficient as the new tree root.

Step 2-3: Place all of the multiple indices of the selected candidates in sequence into {fᵢⱼ|fᵢⱼ=j×fᵢ₀, j=1,2, . . . , N}, and the coefficient thereof is the tree leave.

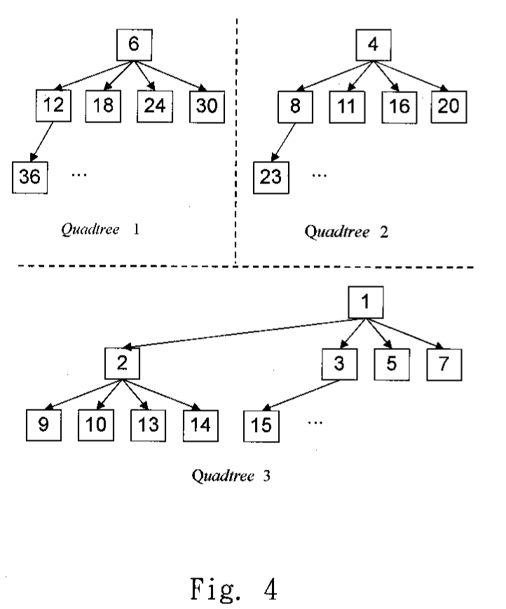

Step 2-4: According to the construction sequence of the complete tree, write to the location of the tree leave of the quad tree, as shown in FIG. 4.

Step 2-5: If the selected multiple indices have already been selected, then select substitute indices gₖ from the multiple indices of the search range for substitution (Step 2-6); if the coefficients in the search range have all been selected, then skip the location of the multiple indices (Step 2-7).

Step 2-8: If the total number of the trees to be constructed Q−1 is not satisfied, then return to Step 2-2. In FIG. 2, the value Q is set at 3.

For all the remaining coefficients that have not been selected, the coefficient with index of 1 is used as root, and the coefficients are placed in order to construct a complement quad tree.

The restoration procedure is the same as the construction procedure. Starting from the tree root, the original selection procedure is changed to writing procedure. When a coefficient is written, look for a location that has not been written in the search range as mentioned in Step 2-5.

The aforementioned CEIHT algorithm and AC are explained below:

CEIHT is an improved algorithm based on set partitioning in hierarchical tree (SPIHT). SPIHT is a less complicated compression, mainly employing a relationship constructed by the tree structure and a binary level. CEIHT combines the coefficient in SPIHT and utilizes the principle of entropy coding to enhance the compression rate. Entropy coding uses AC. The following description defines the terms used in CEIHT and AC:
Significant: testing a set to see if any value larger than a threshold exists;

$${S}_{n} ( τ ) = \{ \begin{matrix}1 , & {max}_{( i ) ∈ τ} \{ \vert {C}_{i} \vert \} \geq {2}^{n} \\ 0 , & otherwise\end{matrix} ,$$

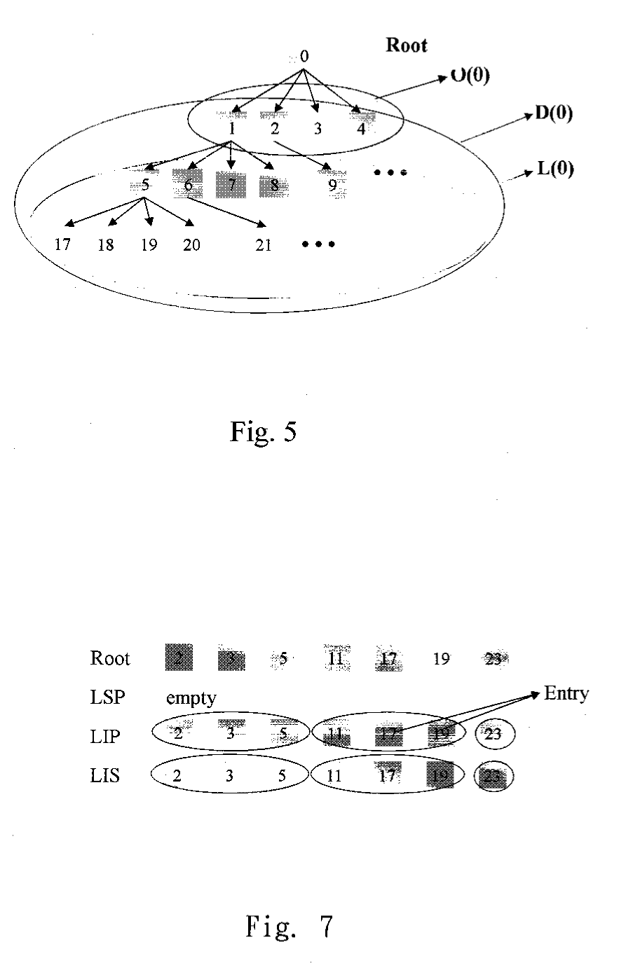

the testing formula is as follows:
τ is the name of the set, Cᵢ is the value of the i-th coefficient in the set, 2ⁿ is the threshold value, if the output is 1, then it is significant; otherwise, it is insignificant.
Tree structure-related terms:
   Offspring refers to the child of a node; O(i) refers to the set of all children of node i; O(0) shown in FIG. 5 is the offspring of node 0.
   Descendants are all children and grandchildren of the node; D(i) refers to the set of all children and grandchildren of node i; D(0) shown in FIG. 5 is the descendants of node 0.
   L(i): D(i,j)-O(i,j) refers to the set of children and grandchildren other than the offspring; L(i) refers to the result of the i-th node; D(0) shown in FIG. 5 is the result of node 0.
List applied to SPIHT algorithm:
   LIP: list of insignificant pixels
   LSP: list of significant pixels
   LIS: list of insignificant sets

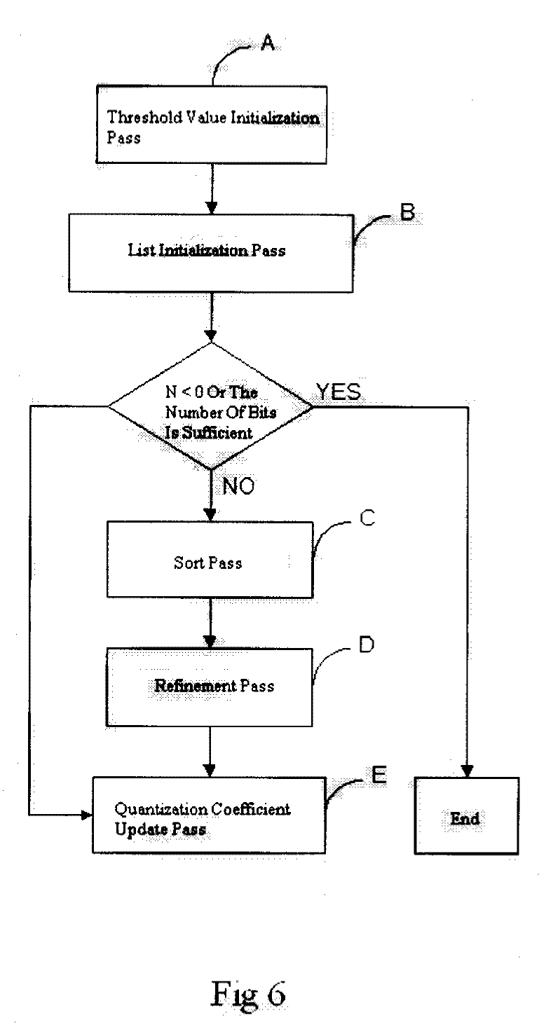

As shown in FIG. 6, CEIHT algorithm includes:
Procedure A: threshold value initialization pass;
Procedure B: list initialization pass,
Procedure C: sort pass;
Procedure D: refinement pass; and
Procedure E: quantization coefficient update pass.

As shown in FIG. 7, the aforementioned Procedure A: threshold value initialization pass includes the following steps:
Step A-1: initialize the threshold value;
Step A-2: search for the coefficient having the largest absolute value in the entire tree structure, and define the largest coefficient as Cₘₐₓ;
Step A-3: calculate coefficient n with the formula of n=└log₂(Cₘₐₓ)┘;
Step A-4: output the value n and use 2ⁿ as the initial threshold value.

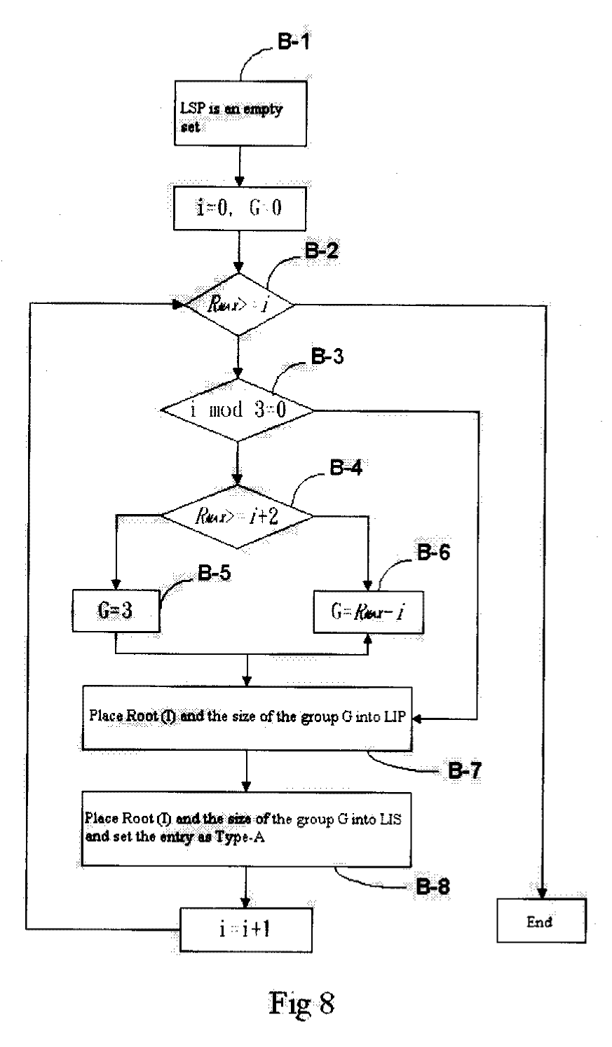

As shown in FIG. 8, the afore-mentioned Procedure B: list initialization pass includes the following steps (Refer to FIG. 7):
Step B-1: Set the list of insignificant pixels (LSP) as an empty set;
Steps B-2˜B-6: For all of the roots in LIP and LIS, create a group for every 3 roots, the remaining roots less than 3 roots are also grouped into one group;
Step B-7: In the list, every information is referred to as an entry; place the information for each root in the tree structure into LIP;
Step B-8: Placing the information for each root in the tree structure into LIS, and set the entry within LIS as Type-A.

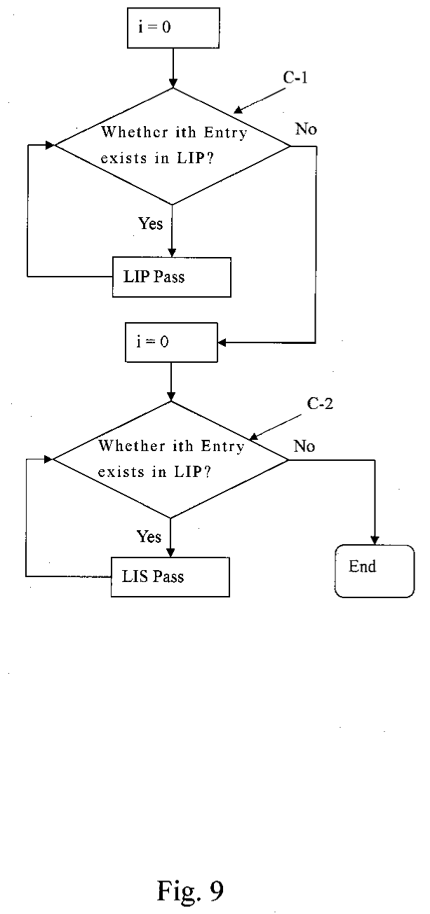

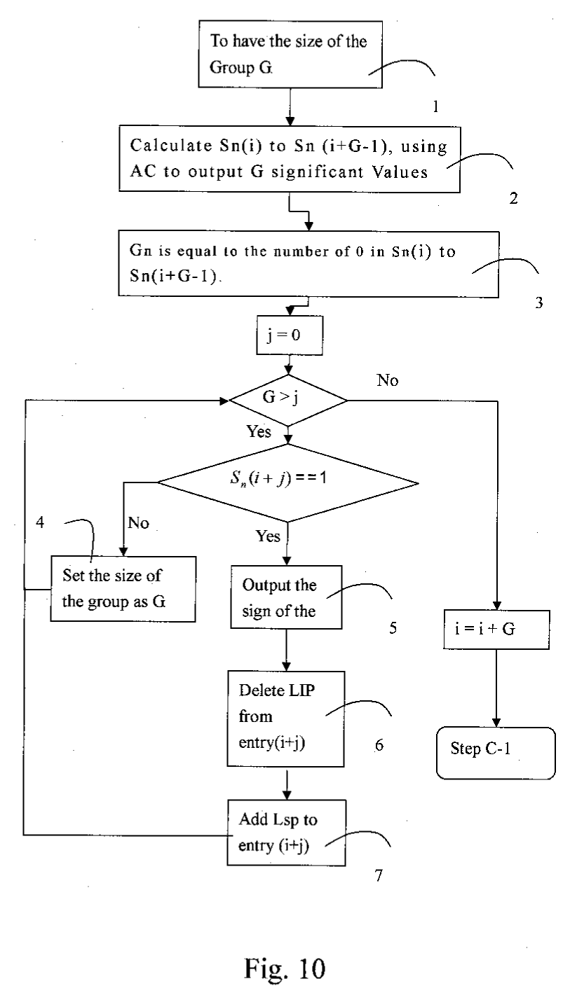

As shown in FIG. 9, the aforementioned Procedure C: sort pass includes the following steps:
Step C-1: determine whether the i-th entry in LIP exists; if so, then execute LIP pass; otherwise, go to Step C-2, and
Step C-2; determine whether the i-th entry in LIS exists; if so, then execute LIS pass; otherwise, execute refinement pass.

The aforementioned LIP pass includes.
Step C-1-1: Set the size of the group obtained from the entry as G;
Step C-1-2: Determine whether the entry i within the same group in LIP is a significant Sₙ(i), and output a number of G parameters Sₙ(i) as outputs,
Step C-1-3: Set Gn as the number when Sₙ(i) . . . Sₙ(i+G−1) is 0;
Step C-1-4: When determining whether Sₙ(i) in the group is 1, output the entry with the positive and negative value of the coefficient, and delete it from LIP and add it to LSP;
Step C-1-5: When determining whether Sₙ(i) in the group is 0, set Gn as the number for the next group; and
Step C-1-6: Return to Step C-1 and determine whether the i-th entry in LIP exists, if not, execute LIS pass.

The aforementioned LIS pass includes the following steps:
Step C-2-1: Set the size of the group obtained from the entry as G;
Step C-2-2: Determine the type of the first entry in the group in LIS; execute the corresponding step based on the type belonged. (This is because the type of the entry in the same group is all the same, and thus determination only needs to be made to the first entry).

The result of the determination should be divided into Type A, Type B and Type C.

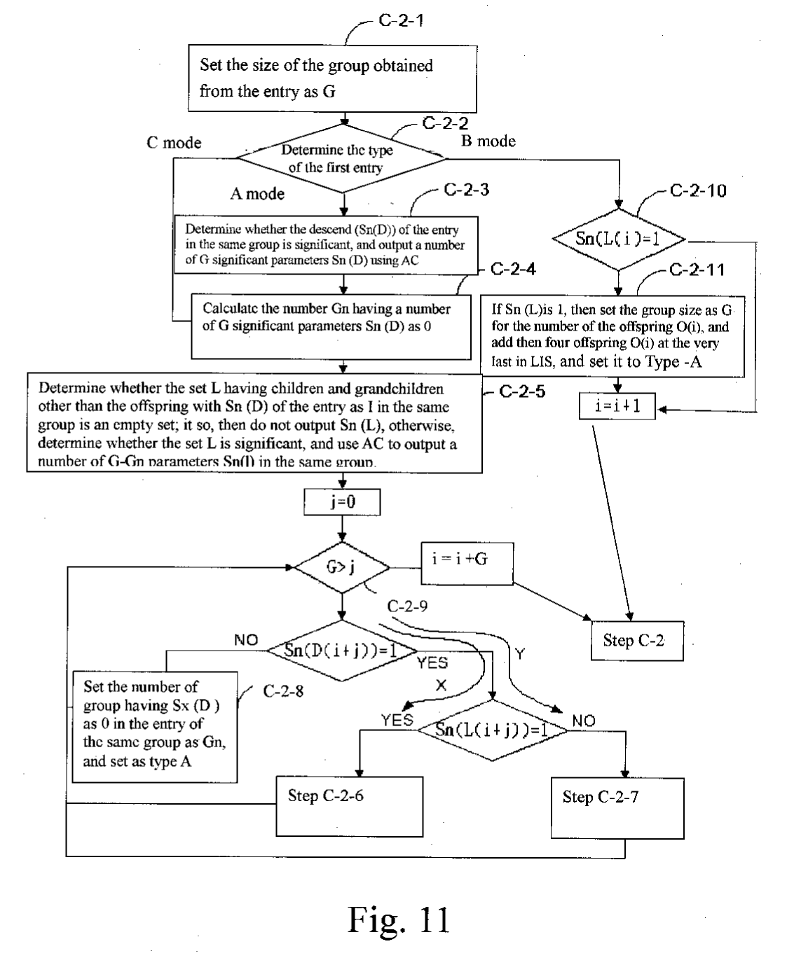

If the result is Type-A: (as shown in FIG. 11)
Step C-2-3: Determine whether the descendant (Sₙ(D)) of the entry in the same group is significant, and output a number of G significant parameters Sₙ(D) using AC;
Step C-2-4: Calculate the number Gn having a number of G significant parameters Sₙ(D) as 0;
Step C-2-5: Determine whether the set L having children and grandchildren other than the offspring with Sₙ(D) of the entry as 1 in the same group is an empty set; if so, then do not output Sₙ(L); otherwise, determine whether the set L is significant, and use AC to output a number of G-Gn parameters Sₙ(L) in the same group;
Step C-2-6: If Sₙ(D) in the entry of the same group is 1, and the corresponding Sₙ(L) is 1, (as shown in the direction X), then determine whether the 4 offspring are of significant value (Sₙ(O)) and output the value Sₙ(D) of the 4 offspring and 8 bits using AC; the positive and negative values of the coefficients of the 4 offspring are also outputted and added to LIS, and set as type-C; the entry is deleted from LIS;
Step C-2-7: if Sₙ(D) of the entry in the group is 1, and the corresponding Sₙ(L) is 0, (as shown in the direction Y), then determine whether 4 offspring is of significant value (Sₙ(O)) and are outputted by AC; if L is not an empty set, then the type of the entry is changed to type-B, and the entry is placed in the very last in LIS; if it is an empty set, then the entry is deleted from LIS;
Step C-2-8: Set the number of group having Sₙ(D) as 0 in the entry of the same group as Gn, and set as type A;
Step C-2-9: Whether the entries in the group are determined completely; if so, then return to Step C-2; otherwise, execute C-2-6, or C-2-7, or C-2-8 depending on the condition.

If it is Type-B:
Step C-2-10: output Sₙ(L); and
Step C-2-11: If Sₙ(L) is 1, then set the group size as G for the number of the offspring O(i), and add the four offspring O(i) at the very last in LIS, and set it to Type-A, and deleted the entry from LIS. Execute Step C-2.

If it is Type-C:

Execute from Step C-2-4 of Type A to Step C-2-9 (this is because Sₙ(D) has been outputted at the previous Type A, and thus skip Step C-2-3). Execute Step C-2.

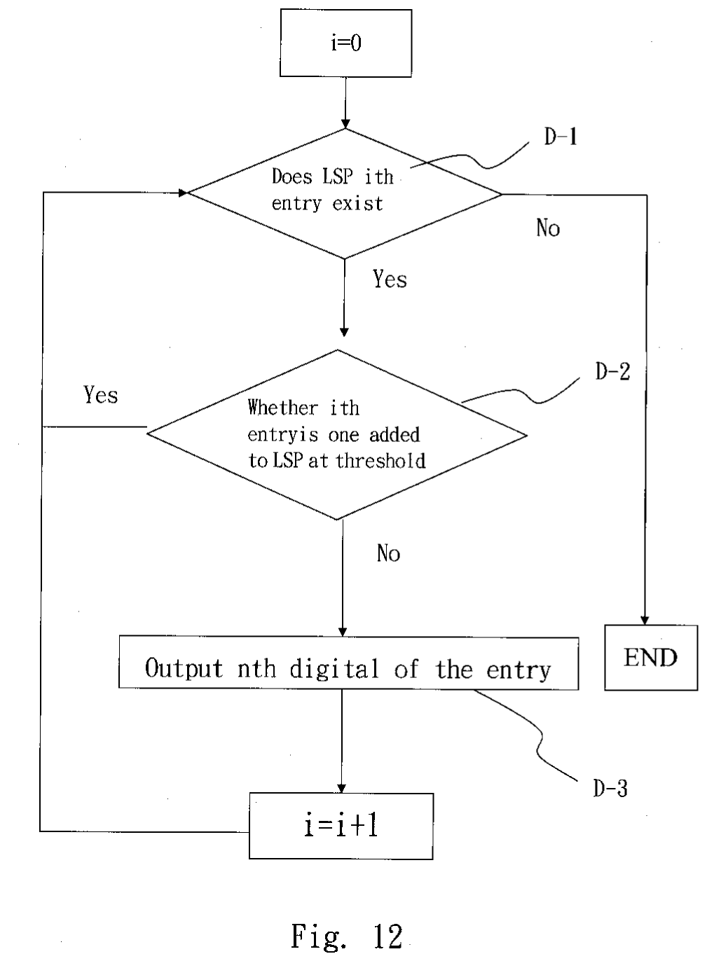

As shown in FIG. 12, the aforementioned Procedure D: refinement pass includes the following steps.
Step D-1: determine whether the i-th entry in LSP exists;
Step D-2: add to LSP when determining whether the current entry is at threshold value 2ⁿ; and
Step D-3: if so, then return to Step D-1; otherwise, output the n-th bit of the coefficient Cᵢ of the entry, and proceed to determine the next element.

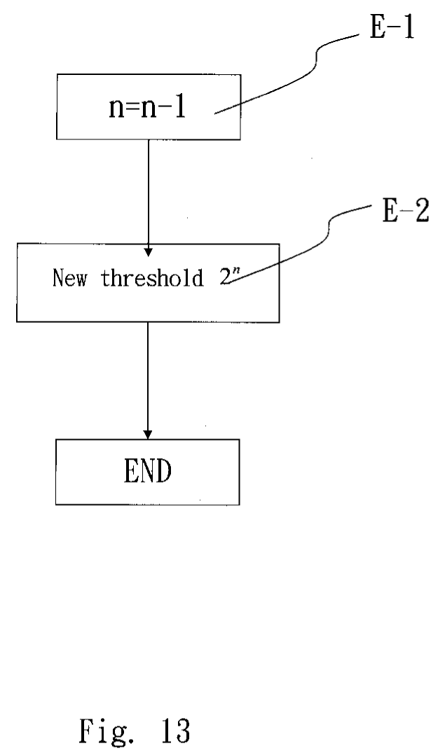

As shown in FIG. 13, the aforementioned Procedure E: quantization coefficient update pass includes the following steps:
Step E-1: If n is not equal to 0, then subtract n by 1; and
Step E-2: Set the new threshold value as 2ⁿ.

Arithmetic coding (AC) is a way to determine the number of storage bits using the occurrence probability of a symbol; the higher the occurrence probability, the fewer the bits needed to be stored, and vice versa. Thus, using AC needs to record the occurrence probability of each symbol. Symbols used in the arithmetic coding of the algorithm includes Sₙ(i) in LIP, Sₙ(D) in LIS, Sₙ(L) in LIS, Sₙ(L) in LIS, (Sₙ(O)) in LIS, and (Sₙ(O)) in LIS, and Sₙ(D) in the 4 offspring; wherein the number of symbols corresponding to arithmetic coding for Sₙ(i) in LIP, Sₙ(D) in LIS, Sₙ(L) in LIS, Sₙ(L) in LIS will vary depending on the group size; the group size varies from 1 to 4. Thus, the corresponding number of symbols is 2^{x}, X ε{1,3,4}; the symbol of (Sₙ(O)) in LIS is fixed at 2⁴, and the symbols of (Sₙ(O)) in LIS and Sₙ(D) in 4 offspring are fixed at 2⁸. A corresponding table is constructed according to the above symbols. When arithmetic coding outputs a bit, the output will refer to the corresponding table for the frequency.

With respect to decompression, all tree structure coefficients are initially set as 0, n is read, and algorithm procedures are executed the same way as compression. The output executed during compression is changed to read for decompression. Additionally, when Sₙ=1, the corresponding coefficient is set to 2ⁿ⁻¹+2ⁿ, and the positive and negative value is set according to the positive and negative value of the read. In refinement pass where the bit is read out as 1, the current coefficient is added with 2ⁿ⁻¹; otherwise, it is subtracted with 2ⁿ⁻¹.

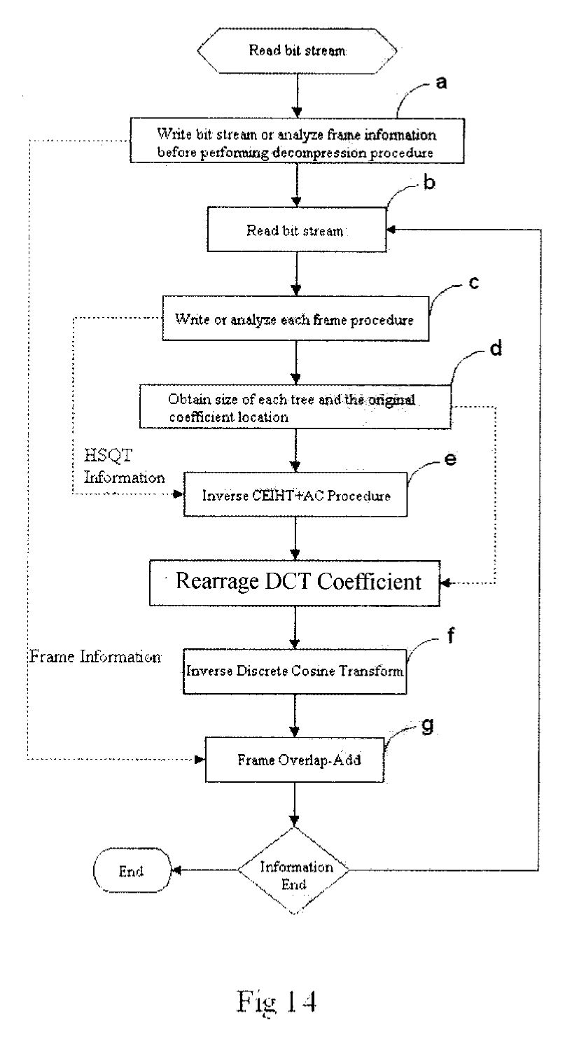

As shown in FIG. 14, decompression procedure is basically in inverse order of the encoding procedure; the procedural steps include:

Step a. write bit stream or analyze frame information before performing decompression procedure;

Step b. read bit stream;

Step c. write or analyze each frame procedure;

Step d. Since HSQT is not always a full quad tree, CEIHT algorithm needs the size information for each tree so as to determine whether the decompression for each tree is completed; the size of each tree can be obtained by the frame length and the location of each tree root using HSQT restoration procedure. Thus, after the decompression procedure restores the location of each tree root, the size of each tree and the original coefficient location can be obtained;

Step e. The information on the encoding coefficient and the size of the tree are decompressed with the original coefficient using the Inverse CEIHT+AC procedure, and at last, it is written back to the coefficient location based on the HSQT restoration procedure;

Step f. Use the inverse discrete cosine transform (DCT) to restore the signal from frequency domain to time domain; and

Step g. Frame Overlap-add as shown in FIG. 15, where window is adopted with a transformation of Hanning window, and the formula is as follows:

$$w ( i ) = \{ \begin{matrix} 0.5 - 0.5 cos ( \frac{2 π i}{M} ) , & i ∈ [ 0 , M / 2 ] \\ 1 , & i ∈ ( M / 2 , N - M / 2 ) \\ 0.5 - 0.5 cos ( \frac{2 π ( i - N + M )}{M} ) , & i ∈ [ N - M / 2 , N ]\end{matrix}$$

N is the frame size, M/2 is the overlap-add size.

Although the present invention has been disclosed with the above preferred embodiments it is not meant to limit the present invention. Those skilled in the art may modify or change the embodiment without leaving the spirit and scope of the present invention. Thus, the scope of the claim is set forth in the claims below.

What is claimed is:

1. A compressing method for a digital audio file, comprising:
writing an audio file signal or analyzing an audio file information prior to encoding procedures;
reading audio raw data;
cutting out a frame from a signal according to a frame size and an overlap-add size;
using a discrete cosine transform or inverse transform,
using a harmonic structure quad tree; and
encoding a frequency coefficient by employing a CEIHT algorithm and arithmetic coding (AC) on said harmonic structure quad tree so as to complete encoding of a frame.

2. The method of claim 1, wherein said means of writing said audio file signal or analyzing said audio file information includes sampling rate, word length, frame size, total number of frame and overlap-add size.

3. The method of claim 1, wherein said discrete cosine transform adopts N point Fast Fourier Transform so as to increase a computing speed.

4. The method of claim 1, wherein said harmonic structure quad tree construction is a tree structure established in accordance with relationships between a magnitude and a power of frequencies in an audio signal.

5. The method of claim 4, wherein said harmonic structure quad tree construction procedure includes the following steps:
a. Selecting a candidate that has not be selected from a candidate list and setting a coefficient thereof as a new root;
b. Setting said coefficient of all multiple indices of said selected candidate as leaves;
c. Writing tree leaves location of quad tree according to a full tree construction sequence;
d. If said selected multiple indices have already been selected, then searching for a substitute indices that has not been selected from a search range of said multiple indices for substitution; if said coefficient in said search range has all been selected, then skipping the multiple indices location;
e. If the number of trees to be constructed is not yet satisfied, then returning to Step a; and
f. For all remaining coefficients that have not been selected, setting a coefficient with an index of 1 as root and placing the others in sequence so as to construct a complement quad tree.

6. The method of claim 5, wherein said selection means of said candidate selection sequence in said Step a is an absolute value of said coefficient of a discrete cosine transform in said search range, placed from a large value to a small value.

7. The method of claim 1, wherein said CEIHT algorithm includes initialization pass, list initialization pass, sort pass, and refinement pass.

8. The method of claim 1, wherein an occurrence probability of said sampling rate is used to determine a storage bit, the higher the probability, the fewer the bits needed for storage, and vice versa.

9. The method of claim 1, wherein said CEIHT algorithm includes:
a. Threshold initialization pass;
b. List initialization pass;
c. Sort pass;
d. Refinement pass; and
e. Quantization coefficient update pass.

10. The method of claim 9, wherein said threshold initialization pass includes the following steps:
a. Threshold initialization;
b. Searching for a coefficient having the largest absolute value in said tree structure and defining said coefficient as Cₘₐₓ;
c. Calculating coefficient n with a formula: n=└log₂(Cₘₐₓ)┘; and
d. Outputting the value of n, and set 2ⁿ as said initial threshold value.

11. The method of claim 9, wherein said list initialization pass includes the following steps:
a. Setting said list of significant pixels (LSP) as an empty set;
b. For all roots in said list of insignificant pixels (LIP) and said list of insignificant sets (LIS), creating a group for every 3 roots and grouping the remaining roots less than 3 into one group;
c. Placing information of each root in said tree structure in said list of insignificant pixels (LIP); and
d. Placing information of each root in said tree structure in said list of insignificant sets (LIS), and setting an entry in said list of insignificant sets (LIS) as Type-A.

12. The method of claim 9, wherein said sort pass includes the following steps:
a. Determining whether the i-th entry in said list of insignificant pixels (LIP) exists, and if so, then performing said list of insignificant pixels (LIP) process; otherwise, performing Step b; and
b. Determining whether the i-th entry in said list of insignificant sets (LIS) exists, and if so performing said list of insignificant sets (LIS) process; otherwise, performing said refinement pass.

13. The method of claim 12, wherein said list of insignificant pixels (LIP) pass includes the following steps:
a. Setting a group size obtained from said entry as G;
b. Determining whether said entry i in the same group in said list of insignificant pixels (LIP) is a significant value Sₙ(i), and using AC to output a number of C parameters Sₙ(i) for outputs;
c. Setting Gn as the number when Sₙ(i) . . . Sₙ(i+G−1) is 0;
d. For determining whether Sₙ(i) in the group is 1, outputting said entry with a positive and negative value of a coefficient, and deleting it from said list of insignificant pixels (LIP), and adding it in said list of significant pixels (LSP),
e. For determining whether Sₙ(i) in the group is 0, setting Gn as the number for the next group; and
f. Returning to said Step a of sort pass, to determine determining whether the i-th entry in said list of insignificant pixels (LIP) exists, and if not, then performing said list of insignificant sets (LIS) pass.

14. The method of claim 12, wherein said list of insignificant sets (LIS) pass includes the following steps:
a. Setting a group size obtained from said entry as G; and
b. Determining a type of the first entry in said list of insignificant sets (LIS) (Type-A, Type-B and Type-C).

15. The method of claim 14, wherein said Type-A pass includes the following steps:
a. Determining whether a descendant (Sₙ(D)) in said entry of the same group is significant, and outputting a number of G significant parameters Sₙ(D) using arithmetic coding (AC);
b. Calculating the number Gn when the number of G significant parameters Sₙ(D) is 0;
c. Determining whether the set L of children and grandchildren other than the offspring of said entry having Sₙ(D) of 1 in the same group is an empty set, and if so, then setting Sₙ(L)=0; otherwise, determining whether the set L is significant, and using arithmetic coding (AC) to output a number of G-Gn parameters Sₙ(L) in the same group,
d. If the Sₙ(D) of the entry in the group is 1, and the corresponding Sₙ(L) is 1 (as shown in the direction X), then determining whether 4 offspring have significant value (Sₙ(O)) and outputting Sₙ(D) of said 4 offspring, and 8 bits using arithmetic coding (AC), and outputting a positive and negative value of said coefficient of said 4 offspring, and adding into said list of insignificant sets (LIS), and setting as type-C, and deleting said entry from said list of insignificant sets (LIS);
e. If Sₙ(D) of said entry in said group is 1, and the corresponding Sₙ(L) is 0, then determining whether 4 offspring have significant value (Sₙ(O)), and outputting with arithmetic coding (AC), if L is not an empty set, then changing said type of said entry to type-B, and placing said entry to the very last of said list of insignificant sets (LIS), if it is an empty set, then deleting said entry from said list of insignificant sets (LIS);
f. Setting the number of entry in said group having Sₙ(D) of said entry in said group as 0 as Gn, and set to type-A; and
g. Determining whether all entries in said group are determined, and if so, then returning to said step b of sort pass, or performing Step d, or Step e, or Step f depending on the condition.

16. The method of claim 14, wherein said Type-B pass includes the following steps:
a. Outputting Sₙ(L); and
b. If Sₙ(L) is 1, then setting the number of offspring O(i) as said group size of G, and adding 4 offspring O(i) to the very last of said list of insignificant sets (LIS), and setting as Type-A, and deleting said entry from said list of insignificant sets (LIS), and performing said step b of sort pass.

17. The method of claim 14, wherein said Type-C pass includes the following steps:
a. Calculating the number Gn where a number of G significant parameters having Sₙ(D) of 0;
b. Determining whether the set L having children and grandchildren other than the offspring with Sₙ(D) of 1 in said entity of said same group is an empty set, and if so, then setting Sₙ(L)=0; otherwise, determining whether the set L is significant, and using arithmetic coding (AC) to output the parameter value Sₙ(L) for a number of G-Gn in the same group;
c. If Sₙ(D) of the entry in the group is 1, and the corresponding Sₙ(L) is 1 (as shown in the direction X), then determining whether 4 offspring has significant value Sₙ(O) and outputting the Sₙ(D) of 4 offspring and 8 bits using arithmetic coding (AC), and outputting a positive and negative value of said coefficient of 4 offspring, and adding to said list of insignificant sets (LIS), and setting as type-C, and deleting said entry from said list of insignificant sets (LIS);
d. If the Sₙ(D) of the entry in the group is 1, and the corresponding Sₙ(L) is 0, then determining whether 4 offspring have significant value (Sₙ(O)), and outputting with arithmetic coding (AC), if L is not en empty set, then changing said type of entry to type-B, and placing said entry in the very last of said list of insignificant sets (LIS), if it is an empty set, then deleting said entry from said list of insignificant sets (LIS);
e. Setting the number of entry in the group having Sₙ(D) of said entry in said group as 0 as Gn, and setting to type-A; and
f. Determining whether all entries in said group are determined, and if so, then returning to said step b of sort pass, or performing Step d, or Step e, or Step f depending on the conditions a.

18. The method of claim 9, wherein said refinement pass includes the following steps:
a. Determining whether the i-th entry in said list of significant pixels (LSP) exists;
b. For determining whether the current entry is at threshold value 2ⁿ, adding to said list of significant pixels (LSP); and
c. If so, then returning to Step a; otherwise, outputting the value of the n-th bit of the entry coefficient Cᵢ, and proceeding to determine the next element.

19. The method of claim 9 wherein said quantization coefficient update pass includes the following steps:
a. If the value of n is not equal to 0, then subtracting 1 from said value of n; and
b. Setting a new threshold value at 2ⁿ.

20. The method of claim 1, the corresponding decompressing method comprising:
a. Writing a bit stream and analyzing frame information prior to performing decoding procedures;
b. Reading said bit stream;
c. Writing or analyzing each frame procedure;
d. Obtaining a size of each tree and an original coefficient location after restoring each root location by HSQT;
e. Decoding said original coefficient from encoded coefficient information and said size of tree by employing an Inverse CEIHT+AC, and write to a coefficient location obtained from said HSQT restoration;
f. Using an inverse discrete cosine transform (DCT) to transform signal from frequency domain to time domain; and
g. Performing frame Overlap-add, wherein a window adopts a transformation of Hanning window, the formula is as follows:
$$w ( i ) = \{ \begin{matrix} 0.5 - 0.5 cos ( \frac{2 π i}{M} ) , & i ∈ [ 0 , M / 2 ] \\ 1 , & i ∈ ( M / 2 , N - M / 2 ) \\ 0.5 - 0.5 cos ( \frac{2 π ( i - N + M )}{M} ) , & i ∈ [ N - M / 2 , N ]\end{matrix}$$
wherein N is the frame size, M/2 is overlap-add size.
